(19) United States
(12) Patent Application Publication
(10) Pub. No.: US 2013/0234906 A1
(43) Pub. Date: Sep. 12, 2013

(54) Sleeve Dipole Antenna Microphone Boom

(71) Applicant: Doug Rosener, Santa Cruz, CA (US)

(72) Inventor: Doug Rosener, Santa Cruz, CA (US)

(73) Assignee: Plantronics, Inc., Santa Cruz, CA (US)

(21) Appl. No.: 13/414,981

(22) Filed: Mar. 8, 2012

(51) Int. Cl. H01Q 9/16

(52) U.S. Cl. 343/790

(57) ABSTRACT

Methods and apparatuses for antennas in head worn devices are disclosed. In one example, a boom assembly includes an integrated sleeve dipole antenna. A first boom component is configured as a sleeve radiating element and a second boom component is configured as a radiating element.

### BACKGROUND OF THE INVENTION

Wireless headsets require an antenna to permit a headset transceiver to communicate with a corresponding base transceiver. Antennas used in wireless headsets utilize space that must be considered in the design of the headset. The headset antennas must be small because the headsets themselves are small. For example, the size of headset bodies may be on the order of 30 mm in length or less. However, at the same time, the antennas must still be operable in the desired frequency band:

In the prior art, headset antennas have been constructed using planar inverted-F antennas (PIFAs), resonators, or other designs, on the headset circuit boards. These prior art designs rely on the circuit board to act as a counterpoise and the size of circuit board usually determines performance. For example, PIFA antennas require large ground planes, thereby making it difficult to provide a small device with good antenna characteristics. As the size of headsets decreases, the size of the circuit board and attached antenna necessarily decreases, resulting in performance degradations related to the transmission characteristics and gain of the antenna.

Furthermore, there is a substantial loss of efficiency of these antennas when used near a human head as the human body affects the electromagnetic field radiation pattern of the antenna. In the prior art designs, the headset circuit board is often close to the user head, further degrading performance.

As a result, improved methods and apparatuses for headset antennas are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a simplified cross sectional diagram of a sleeve dipole antenna boom assembly in one example.

FIG. 2 illustrates a simplified disassembled view of select components of the sleeve dipole antenna boom assembly shown in FIG. 1 in one example implementation.

FIG. 3 illustrates a simplified cross sectional diagram of a sleeve dipole antenna boom, assembly in a further example.

FIG. 4 illustrates a simplified disassembled view of select components of the sleeve dipole antenna boom assembly shown in FIG. 3 in one example implementation.

FIG. 5 illustrates a simplified cross sectional diagram of a sleeve dipole antenna boom assembly in which conductive elements are disposed on a plastic housing.

FIG. 6 illustrates a simplified cross sectional diagram of a sleeve dipole antenna boom assembly in which conductive elements are disposed on a plastic housing in a further example.

FIG. 7 illustrates a simplified cross sectional diagram of a sleeve dipole antenna boom assembly in which conductive elements are disposed within a plastic housing.

FIG. 8 illustrates a simplified cross sectional diagram of a sleeve dipole antenna boom assembly in which, conductive elements are disposed within a plastic housing in a further example.

FIG. 9A illustrates a front view of a headset with a boom having a sleeve dipole antenna.

FIG. 9B illustrates a rear view of the headset shown in FIG. 9A.

FIG. 10 illustrates a perspective view of a sleeve dipole antenna boom assembly in a further example.

FIG. 11 illustrates a simplified perspective view of a sleeve dipole antenna boom assembly in one example.

FIG. 12 illustrates the sleeve dipole antenna boom assembly shown in FIG. 11 with an antenna upper arm removed to illustrate an antenna feed and wire assembly shield attachment

### DESCRIPTION OF SPECIFIC EMBODIMENTS

Methods and apparatuses for headset antennas are disclosed. The following description is presented to enable any person skilled in the art to make and use the invention. Descriptions of specific embodiments and applications are provided only as examples and various modifications will be readily apparent to those skilled in the art.

The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Antenna solutions in head worn devices are presented herein. A half-wave dipole antenna is relatively broadband in wireless communication bands and therefore requires little production tuning for narrowband applications like wireless headsets. The half-wave dipole antenna advantageously does not easily detune. A sleeve antenna is one design of a half-wave dipole antenna. The sleeve antenna consists of a dipole, where the feed is brought through one arm of the dipole. Because the feed is within the antenna conductors, it is shielded from the radiating currents. This aids proper performance of the antenna.

However, the half wave dipole antenna requires a quarter wavelength for each arm (on the order of 30 mm for the Bluetooth band at 2.45 GHz in free space). This length can be reduced by putting plastic near the radiators, but the more this techniques is used, the less efficient the antenna. Unfortunately, the size of the main capsule of many Bluetooth headsets today is much less than 60 mm (both anus of dipole), thereby effectively preventing the use of a half wave dipole antenna. But many headsets have a microphone boom (for example, an elongated structure) attached to enhance microphone performance by placing an acoustic wave sensing point closer to a user mouth. The closer the boom tip is to the mouth, generally the better performance. The distance from ear to mouth is on the order of 80 mm or more. In one example of the invention, a Bluetooth band half-wave sleeve dipole is advantageously accommodated in the boom. Advantageously, antenna performance is improved as the antenna is held further away from the head than in designs with the entire antenna entirely in the capsule, reducing the amount of power absorption and detuning resulting from the user head. Furthermore, the antenna is a half-wave dipole with one arm acting as a counterpoise, rather than a quarter-wave monopole with the ground (counterpoise) provided by the PCB in the headset capsule. This also reduces the power absorption and detuning due to the user head in these designs. Finally, the arms of the sleeve dipole acts as a balun, reducing the currents induced on the feed and conducted into the PCB, providing isolation, pattern improvement, better efficiency and less detuning. In one example, the internal microphone assembly may extend beyond the end of the tube connected to the inner conductor of the coax, with the same balun effect. In this case, the microphone must have a conductive coaxial shield around them and extend beyond the end of the tube as well. This shield must form a transmission line with the antenna tube connected to the inner connector of the coax.

The microphone boom can be constructed with the microphone at the tip, connected by conducting wires to the headset or be constructed with an air tube that conducts the sound to a microphone embedded in the headset. In a further example, the microphone may be located anywhere within the boom. There can be small openings and slots in the metal tubes (and plastic) that allow for multiple microphones. The small openings do not disturb the radiation significantly as long as they are less than λ/10 where λ is the desired radiation wavelength of the antenna. For comfort, the booms are often away from the face rather riding directly on it.

In one example the function of the boom of the headset used for audio is combined with a half-wave sleeve dipole used for RF. A variety of configurations may be implemented depending upon whether the boom is air tube or microphone wired and whether the boom is extensible or fixed.

In one example, a boom assembly includes an integrated sleeve dipole antenna. A first boom component is configured as a sleeve radiating element and a second boom component is configured as a radiating element.

In one example, a boom assembly includes a RF feeding coaxial cable having an outer conductor and a central conductor. The boom assembly includes a first boom component, the first boom component coupled to the central conductor and configured as an antenna radiating clement. The boom assembly includes a second boom component electrically isolated from the first boom component, where the second boom component has a portion of the RF feeding coaxial cable disposed within and the second boom component is coupled to the outer conductor and configured as an antenna sleeve radiating element.

In one example, a headset includes a body configured to be worn on a user ear and a boom coupled to the body. The boom coupled to the body includes a radiating element, and a sleeve radiating element arranged to be electrically isolated from the radiating element. A RF feeding coaxial cable is disposed within the sleeve radiating element. The RF feeding coaxial cable includes an outer conductor and a central conductor, where the outer conductor is coupled to the sleeve radiating element.

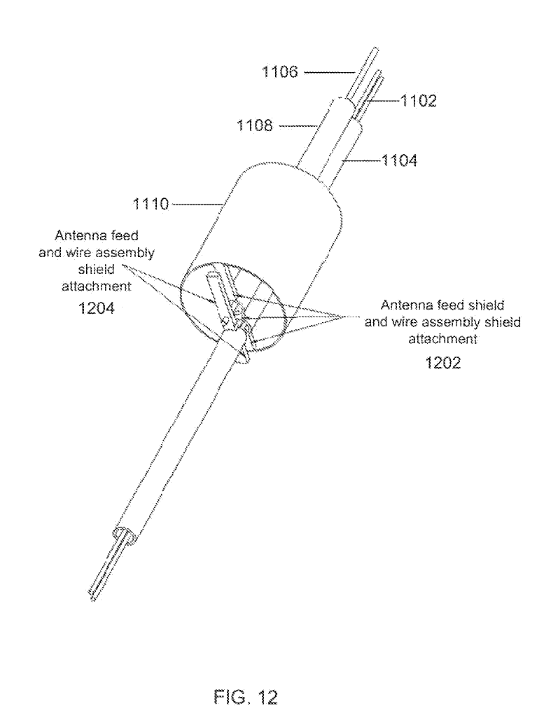

In one example implementation for a fixed boom with microphone wires, the boom consists of two metal tubes electrically insulated from each other and insulated from the main headset housing. The microphone wires are passed from the headset base to the boom end through the tubes. In one example, the microphone wires are advantageously in a coaxial structure or shield tube with the external conductor/tube grounded to the same potential as the antenna feed shield as shown in FIG. 11 and FIG. 12. FIG. 11 illustrates a simplified perspective view of a sleeve dipole antenna boom assembly in one example. FIG. 12 illustrates the sleeve dipole antenna boom assembly shown in FIG. 11 with an antenna upper arm removed to illustrate an antenna feed and wire assembly shield attachment. As shown in FIG. 11, a sleeve dipole antenna boom assembly 1100 includes a wire assembly 1102 in a wire assembly shield 1104, an antenna feed 1106 in an antenna feed shield 1108, an antenna lower arm 1110, and antenna upper arm 1112. Referring to FIG. 12, the antenna feed 1106 consists of a coaxial wire brought to the insulating section. The shield 1108 of the feed coaxial cable connects to antenna lower arm 1110 (e.g., a metal tube) utilizing antenna feed shield and wire assembly shield attachment 1202, and the center conductor of the antenna feed 1106 coaxial cable connects to antenna upper arm 1112 (not shown for clarity) utilizing antenna feed and wire assembly shield attachment 1204. Microphone wire assembly shield 1104 connects to antenna lower arm 1108 via antenna feed shield and wire assembly shield attachment 1202 and connects to antenna upper arm 1112 via antenna feed and wire assembly shield attachment 1204.

While in certain examples the microphone wires are outside the antenna metal tubes, generally, antenna performance will be better with them within the tubes and in the preferred embodiment, advantageously within their own shield tube at the same potential as the antenna feed shield. If necessary, the feed shield and wire assembly shield can be electrically tied periodically along their edges to maintain equal potential The lower antenna tube forms a high-impedance with the coax feed and optional wire assembly shield, reducing induced currents that might change the antenna pattern or resonant frequency. The isolation of the metal tubes from the headset makes the antenna performance relatively unaffected from the headset conductor (PCB, case) size.

Further construction possibilities include having the center conductor of the feed coaxial cable exiting the first tube fanning out and becoming a cone that terminates all around the edge of the next tube, and the outer conductor fanning out and back and terminating all around the first tube. Any other conductors, like the boom microphone lead is fed through an aperture in these two structures.

In various examples, the two metal tubular sections can be made of extruded metal tubing, stamped metal folded/or bent on itself, or deposited metal coating on plastic. In addition, the metal can be covered in plastic or some other insulator. The dielectric constant of the insulator affects the length of the metallic sections.

For a fixed, boom with an, air tube, one example is to embed the air tube into the metal tubes used for the microphone wired solutions. However, it is undesirable for the coaxial cable to be inside the air tube for acoustic reasons (changes air tube acoustic properties, and requires a puncture of tube to pass coaxial cable wires). In further examples, a better solution is to have the coaxial cable sit side-by side with the air tube. This can be a custom molded part consisting of tube and coaxial cable. In this configuration, one could also have the air tube external to the metal tubes, with no degradation of performance. Finally, one can use the center conductor of the coaxial cable to replace one of the metal tubes.

For the extensible boom (e.g., a telescoping boom), it is required that the metal tubes slip between each other, but maintain their electrical isolation, and moving the wires/coaxial cable so they do not bind. The two metal tubes have differing diameters so that one can slide into the other.

Advantageously, because the boom is usually away from the face, there is less absorption and detuning of the antenna when it is collocated with the boom. Advantageously, the antennas dependence on the headset properties for performance is reduced. The antennas described herein may serve as a platform that can be used with many headset designs. Furthermore, the designs described herein free up real-estate that is usually required on the headset for the antenna.

In a further example, the solid coaxial nature of the antenna arms is not required. It is acceptable to have slits along the antenna if they are connected at the antenna feed as in the coaxial case and they remain equipotential to each other. One or more slits may be used as desired. If necessary, they can be electrically tied periodically along their edges to maintain equal potential. In particular, one embodiment consists of four substantially planar (curved or flat) plates where each arm of the antenna consists of two plates.

In one planar embodiment utilizing an air tube microphone, the antenna feed is coaxial. The outer conductor is soldered to a lower planar part and the center conductor is soldered to an upper planar part.

In a second planar embodiment utilizing microphone or other leads (i.e., auxiliary wires), the auxiliary wires are attached to the boom sleeve dipole. In one example, there is only one auxiliary wire which is the center conductor of the coaxial wire assembly, but there can be more than one wire internal to the coaxial wire assembly. In one example they are coaxial, but this is not a requirement. However, it is required that the auxiliary transmission line ground/shield is attached sufficiently well to the antenna feed shield (e.g., lower arm) that it is essentially equipotential with it and forms a transmission line with the antenna lower arm. When the auxiliary wires bridges the gap, the wires leave the ground/shield of the transmission line that is equipotential with the antenna feed and move to form another transmission line whose outer shield is terminated near where the antenna feed terminates on the upper arm and forms a transmission line with the antenna upper arm. When the wires jump the antenna arm gap, the shield must therefore be discontinuous.

FIG. 1 illustrates a simplified cross sectional diagram of a sleeve dipole antenna boom assembly in one example. In this example, a boom assembly 2 includes a RF feeding coaxial cable 8 having an outer conductor 12 and a central conductor 10. The boom assembly 2 includes a first boom component 4, the first boom component 4 coupled to the central conductor 10 and configured as an antenna radiating element. The boom assembly 2 includes a second boom component 6 electrically isolated from the first boom component 4, where the second boom component 6 has a portion of the RF feeding coaxial cable 8 disposed within and the second boom component 6 is coupled to the outer conductor 12 and configured as an antenna sleeve radiating element. In one example, the first boom component 4 has an electrical length of approximately one-quarter wavelength of the frequency of interest (e.g., center frequency of the desired frequency band) and the second boom component 6 has an electrical length of approximately one-quarter wavelength of the frequency of interest.

The boom assembly 2 further includes a microphone 14 disposed at a far end of the first boom component 4, and electrical leads 16 coupled to the microphone, the electrical leads 16 disposed within the first boom component 4 and the second boom component 6. Generally, microphone 14 will utilize two leads 16, but in further examples more leads may be used. Leads 16 are shown in FIG. 1 as a single unit (e.g. line) for clarity. Similarly, the microphone leads in additional figures discussed below may also be shown as a single unit for clarity. Furthermore, there may be multiple microphones distributed inside the boom with small apertures in the tubes and plastic housing. In one example, the microphone leads 16 as well as any other wires extending through the boom (e.g., wires for buttons, LEDs, etc.) are advantageously in a coaxial structure or shield tube with the external conductor/tube grounded to the same potential as the antenna feed.

Although leads 16 and microphone 14 are illustrated in FIG. 1 within the antenna, in one example, the leads 16 as well as any other wires and microphone 14 are extended beyond the antenna if they have a coaxial conductive shield that is connected near the same location as the coaxial inner conductor of the antenna feed, and forms a transmission line as it exits the upper arm.

In one example for 2.4 GHz operation, the length with no plastics on the outside of the first boom component 4 is between approximately 24-30 millimeters and the length of the second boom component 6 is between approximately 24-30 millimeters. The length will depend on the materials used, including whether there is a plastic coating on the metal tube and in general will be shorter when used with a plastic coating. In one example, the first boom component 4 is sized to fit within the second boom component 6 and arranged to extend or retract telescopically with respect to the second boom component 6.

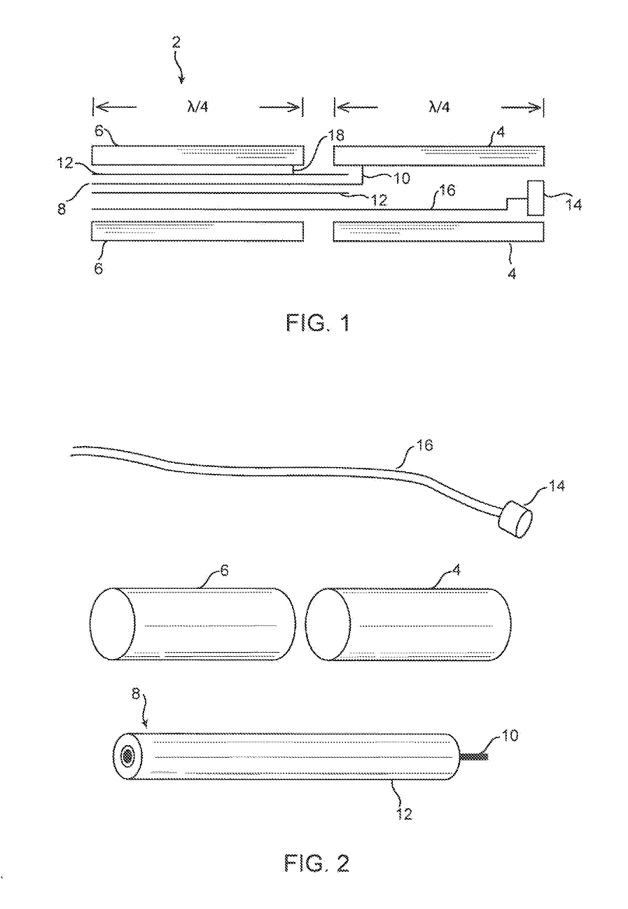

FIG. 2 illustrates a simplified disassembled view of select components of the sleeve dipole antenna boom assembly 2 shown in FIG. 1 in one example implementation. In one example, the first boom component 4 comprises a first plastic member having a first conductive coating and the second boom component 6 comprises a second plastic member having a second conductive coating. For example, the first conductive coating or second conductive coating is a metal deposited on a surface of the first plastic member or a copper foil on a surface of the first plastic member.

In one example, the first boom component 4 is a metal tube and the second boom component 6 is a metal tube. In a further example, the metal tubes are coated with a plastic material or embedded within a plastic material. In one example, an insulating sleeve is disposed between the first boom component and the second boom component.

In operation, boom component 4 operates as a radiating element having an electrical length of approximately one quarter wavelength and boom component 6 operates as a sleeve (e.g., a cylindrical tube) radiating element having an electrical length of approximately one quarter wavelength. The central conductor 10 of coaxial cable 8 is connected to the radiating element (i.e., boom component 4), and the outer conductor 12 of coaxial cable 8 is connected to the sleeve radiating element (i.e., boom component 6). Coaxial cable 8 transmits radio frequency energy from a headset transceiver to the radiating element and sleeve radiating element. The point of transition from the coaxial cable 8 to the radiating element and sleeve radiating element is the antenna feed point and generally located at the junction of the radiating element and sleeve radiating element.

In one example, boom component 6 is a sleeve radiating element consisting of a tubular conductor with an antenna coaxial cable 8 coaxially aligned in the sleeve. The center conductor 10 of coaxial cable 8 extends beyond the point at which the outer conductor 12 is connected to the sleeve tubular conductor. The sleeve tubular conductor makes up the lower half of the antenna radiator and the length dimension is determined from the required length to cause the sleeve to be electrically resonant at the desired frequency.

Boom component 4, boom component 6, and coaxial cable 8 together are operable as a half wave sleeve dipole antenna laving good efficiency, directivity, and stable impedance. Advantageously, the microphone boom and the half wave sleeve dipole antenna utilize the same structural elements.

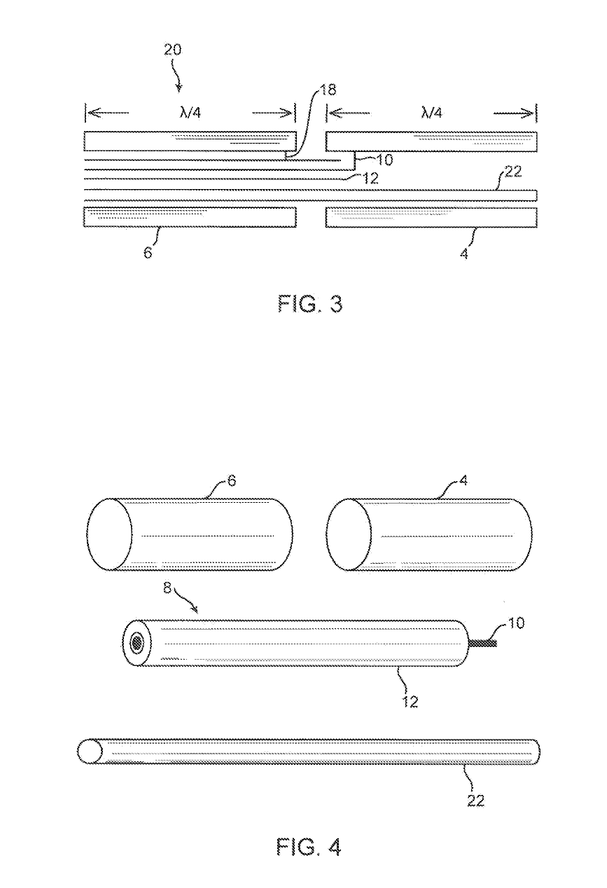

FIG. 3 illustrates a simplified cross sectional diagram of a sleeve dipole antenna boom assembly 20 in a further example. FIG. 4 illustrates a simplified disassembled view of select components of the sleeve dipole antenna boom assembly shown in FIG. 3 in one example implementation. Boom assembly 20 is similar to boom assembly 2 shown in FIG. 1 with the exception that microphone 14 and leads 16 have been replaced with a voice tube 22. In the example shown in FIGS. 3 and 4, the voice tube 22 is utilized to receive acoustic sound waves corresponding to user speech at the distal end of the boom and transmit the acoustic waves the length of the boom assembly 20. The acoustic waves are then detected by microphone disposed at a headset body or the near end of the boom assembly 20.

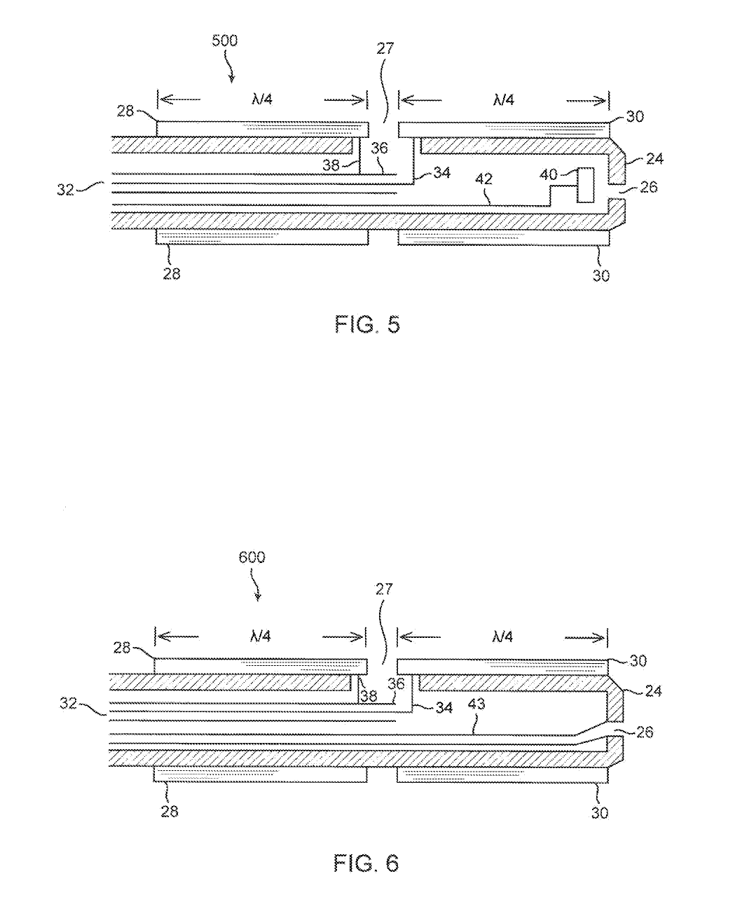

FIG. 5 illustrates a simplified cross sectional diagram of a sleeve dipole antenna boom assembly 500 in which conductive elements are disposed on a plastic housing 24. A boom assembly 500 includes a RF feeding coaxial cable 32 having an outer conductor 36 and a central conductor 34. The boom assembly 500 includes a first boom component 30, the first boom component 30 coupled to the central conductor 34 and configured as an antenna radiating element.

The boom assembly 500 includes a second boom component 28 electrically isolated from the first boom component 30, where the second boom component 28 has a portion of the RF feeding coaxial cable 32 disposed within and the second boom component 28 is coupled to the outer conductor 36 and configured as an antenna sleeve radiating element. In one example, the first boom component 30 has an electrical length of a one-quarter wavelength and the second boom component 28 has an electrical length of a one-quarter wavelength.

The boom assembly 500 further includes a microphone 40 disposed at a far end of the first boom component 30 (i.e., the distal end away from the headset body), and electrical leads 42 coupled to the microphone, the electrical leads 42 disposed within the first boom component 30 and the second boom component 28. The plastic housing 24 includes an aperture 26 at the distal end for transmission of acoustic waves to the microphone 40. A plastic housing 24 also includes an aperture 27. Utilizing aperture 27, the outer conductor 36 of cable 32 is connected to the conductive material of boom component 28 utilizing an electrical connection 38. Similarly, utilizing aperture 27, the central conductor 34 is coupled to the conductive material boom component 30. In this manner, the two RF connections from the coaxial cable come through the same aperture in the housing and connect to adjacent opposite pieces (the ground shield to the tube containing the coaxial cable) for proper phasing of the antenna.

In one example, the first boom component 30 is a formed of a conductive coating disposed on a plastic housing 24 and the second boom component 28 is a conductive coating disposed on the plastic housing 24. As shown in this example, the two conductive coatings are disposed on different sections of the plastic housing 24. Thus, the first boom component and the second boom component may be different sections of a single piece boom.

FIG. 6 illustrates a simplified cross sectional diagram of a sleeve dipole antenna boom assembly 600 in which conductive elements are disposed on a plastic housing in a further example. Boom assembly 600 is substantially similar to boom assembly 500 described above in reference to FIG. 5 except as follows. Instead of utilizing microphone 40, boom assembly 600 utilizes a voice tube 43 disposed within the boom component 30 and boom component 28. The voice tube 43 includes an opening porting to aperture 26 of plastic housing 24. The voice tube 43 receives a user voice sound wave at the distal end and transmits the sound wave to a microphone disposed at a headset housing coupled to the boom assembly 600 at a near end of the boom assembly 600.

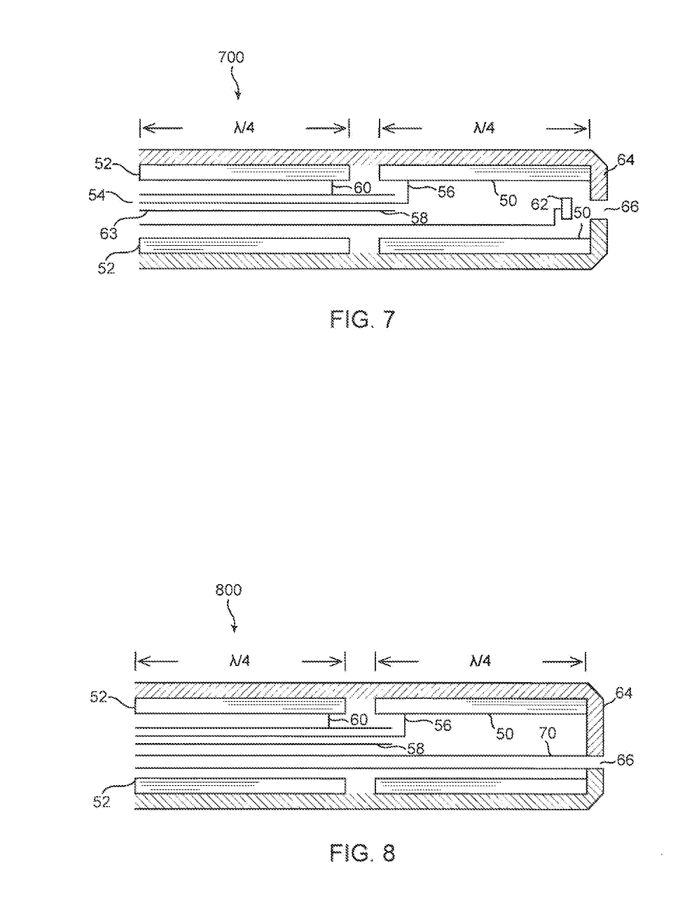

FIG. 7 illustrates a simplified cross sectional diagram of a sleeve dipole antenna boom assembly in which conductive elements are disposed within a plastic housing 64. A boom assembly 700 includes a RE feeding coaxial cable 54 having an outer conductor 58 and a central conductor 56. The boom assembly 700 includes a first boom component 50, the first boom component 50 coupled to the central conductor 56 and configured as an antenna radiating element. The boom assembly 700 includes a second boom component 52 electrically isolated from the first boom component 50, where the second boom component 52 has a portion of the RF feeding coaxial cable 54 disposed within and the second boom component 52 is coupled to the outer conductor 58 and configured as an antenna sleeve radiating element. The first boom component 50 has an electrical length of approximately one-quarter wavelength and the second boom component 52 has an electrical length of approximately one-quarter wavelength.

The boom assembly 700 further includes a microphone 62 disposed at a distal end of the first boom component 50, and an electrical lead 63 coupled to the microphone, the electrical leads 63 disposed within the first boom component 50 and the second boom component 52 and running from the microphone 62 to a near end of boom assembly 700.

The plastic housing 64 includes an aperture 66 at the distal end for transmission of acoustic waves to the microphone 62. The outer conductor 58 of cable 54 is connected to the boom component 52 utilizing an electrical connection 60. The central conductor 56 is coupled to the boom component 50. In one example, the electrical connections are formed using soldering techniques.

In one example, the first boom component 50 is a metal tube and the second boom component 52 is a metal tube, both of which are disposed within plastic housing 64. In a further example, plastic housing 64 is a plastic material deposited upon the metal first boom component 50 and metal second boom component numerals 52.

In a further example, the first boom component 50 is a formed of a conductive coating disposed on an interior surface of plastic housing 64 and the second boom component 52 is a conductive coating disposed on an interior surface of the plastic housing 64.

FIG. 8 illustrates a simplified cross sectional diagram of a sleeve dipole antenna boom assembly 800 in which conductive elements are disposed within a plastic housing in a further example. Boom assembly 800 is substantially similar to boom assembly 500 described above in reference to FIG. 7 except as follows. Instead of utilizing microphone 62, boom assembly 800 utilizes a voice tube 70 disposed within the boom component 50 and boom component 52. Voice tube 70 includes an opening porting to aperture 66 of plastic housing 64. The voice tube 70 receives a user voice sound wave and transmits the sound wave to a microphone disposed at a headset housing coupled to the boom assembly 800.

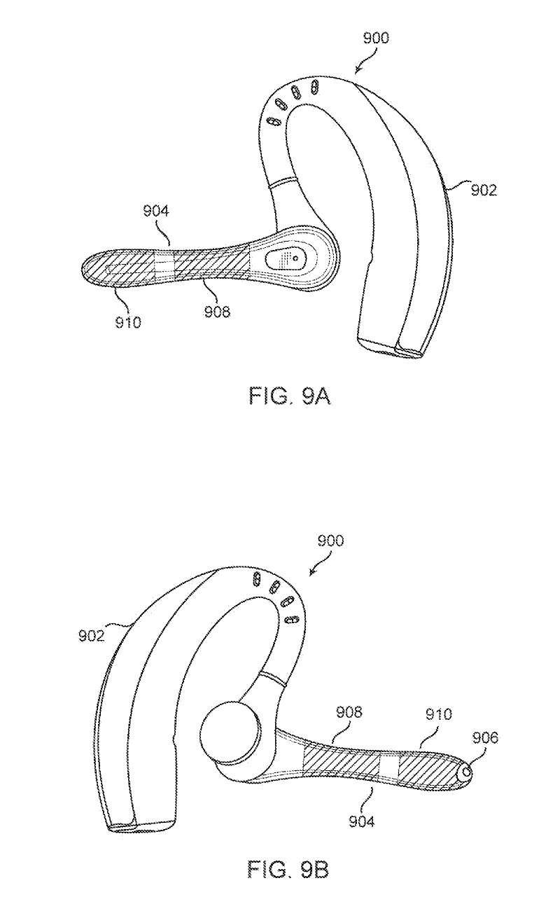

FIG. 9A illustrates a front view of a headset 900 with a boom having a sleeve dipole antenna. FIG. 9B illustrates a rear view of the headset 900 shown in FIG. 9A. Headset 900 includes a body 902 configured to be worn on a user ear and a boom 904 coupled to the body 902. The boom 904 coupled to the body includes a radiating element, and a sleeve radiating element arranged to be electrically isolated from the radiating element. A RF feeding coaxial cable is disposed within the sleeve radiating element. The RF feeding coaxial cable includes an outer conductor and a central conductor; where the outer conductor is coupled to the sleeve radiating element. The central conductor is coupled to the radiating element. The radiating element has an electrical length of approximately one-quarter wavelength and the sleeve radiating element has an electrical length of approximately one-quarter wavelength. In one example, the radiating element and the sleeve radiating element form a boom 904 housing structure. In one example, the radiating element, sleeve radiating element, and RF feeding coaxial cable are disposed within an outer boom housing structure.

The boom 904 comprises an aperture 906 disposed at a distal end of the boom away from the body and arranged to receive a user voice sound wave. In one example, the aperture 906 is coupled to a voice tube disposed within the boom 904 which transmits the sound wave to a microphone disposed at the body 902.

In a further example, the headset 900 includes a microphone disposed at a distal end of the boom away from the body 902, and an electrical lead coupled to the microphone, the electrical lead disposed within the boom 904. In one example, the length of the boom 904 is between approximately 60 millimeters and 80 millimeters, and may be configured to extend or retract in length. In a further example, the length of the boom 904 is 100-120 mm or longer. The plastic inside or outside can be as long as desired. Furthermore, the entire 60 mm or less antenna assembly can be located at the end of the boom.

In one example, the boom 904 is implemented as boom 500 as shown and described above in reference to FIG. 5. In this example, first boom component 28 shown in FIG. 5 is implemented approximately at an area 908 and second boom component 30 is implemented approximately at an area 910 of boom 904. In a further example, the boom 904 is implemented as boom 700 as shown and described above in reference to FIG. 7. In various embodiments, the antenna assembly boom 904 is implemented to transmit and receive on desired frequencies of the headset users, including Bluetooth bands, WiFi bands, digital enhanced cordless telecommunications (DECT) bands, or other frequency bands.

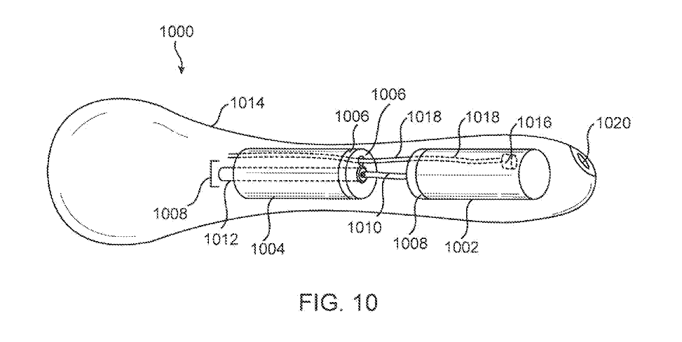

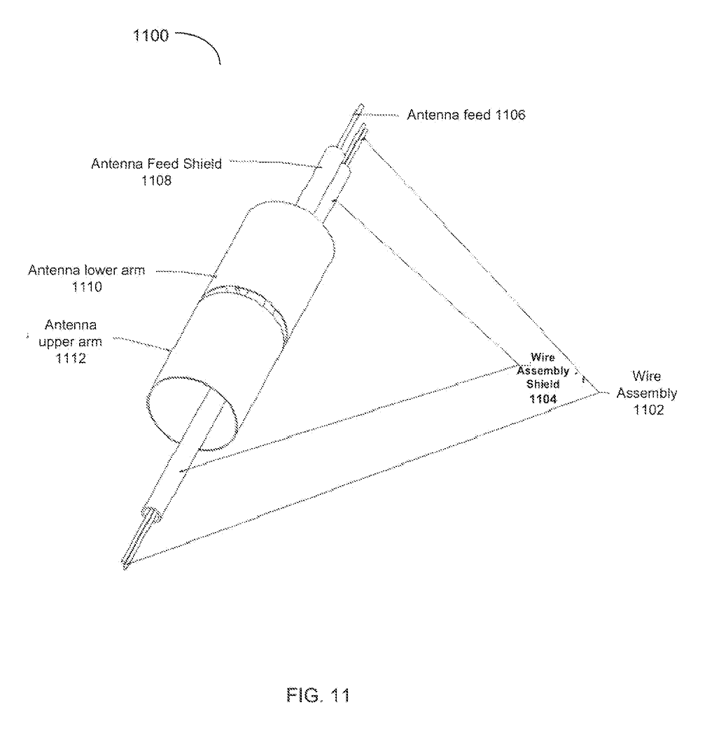

FIG. 10 illustrates a perspective view of a sleeve dipole antenna boom assembly 1000 in a further example. The boom assembly 1000 includes a RF feeding coaxial cable 1008 having an outer conductor 1012 and a central conductor 101.0. The boom assembly 1000 includes a first boom component 1002, the first boom component 1002 coupled to the central conductor 1010 and configured as an antenna radiating element. In the example shown in FIG. 10, a boom component 1004 is a metal tube having a metal cap 1006 on the end which is in proximity to boom component 1002. Similarly, boom component 1002 is a metal tube having a metal cap 1.022 on the end which is in proximity to boom component 1004. Both metal tubes are disposed within a plastic housing 1014.

The boom assembly 1000 includes the second boom component 1004 electrically isolated from the first boom component 1002, where the second boom component 1004 has a portion of the RF feeding coaxial cable 1008 disposed within. The second boom component 1004 is coupled to the coaxial cable outer conductor 1012 by soldering to metal cap 1006, and is configured as an antenna sleeve radiating element. For example, a solder fillet may be utilized to solder the outer conductor 1012 to metal cap 1006. The coaxial cable central conductor 1010 is soldered to metal cap 1022 of boom component 1002 so that boom component 1002 operates as a radiating element.

The boom assembly 1000 further includes a microphone 1016 disposed at a first end of the first boom component 1002, and electrical leads 1018 coupled to the microphone, the electrical lead 1018 disposed within the first boom component 1002 and the second boom component 1004. Microphone leads 1018 may run the length of the metal tubes through an aperture 1020 in the metal cap 1006 and corresponding aperture in metal cap 1022. The first boom component 1002 has an electrical length of a one-quarter wavelength and the second boom component 1004 has an electrical length of a one-quarter wavelength. The plastic housing 1014 includes an aperture 1020 at the distal end for transmission of acoustic waves to the microphone 1016.

In one example, the internal construction of boom assembly 1000 may be implemented with a flexible, rigid or semi-rigid coaxial cable. The tubes used for boom component 1002 and boom component 1004 are capped in metal, with the coaxial cable soldered with a fillet completely around the outer conductor and the entire assembly fit into a plastic tube or is embedded in an injection molded plastic part. The microphone leads 1018 pass through an aperture in the metal tube cap ends. This solution is advantageous for higher frequencies as the impedance is tightly controlled.

In a further implementation, a voice tube running the length of the metal tubes is used in place of microphone 1016 and leads 1018, in which case aperture 1020 in metal cap 1006 and corresponding aperture in metal cap 1022 may be utilized by the voice tube.

While the exemplary embodiments of the present invention are described and illustrated herein, it will be appreciated that they are merely illustrative and that modifications can be made to these embodiments without departing from the spirit and scope of the invention. For example, the boom assemblies described herein may be used with a variety of type of electronic devices. Thus, the scope of the invention is intended to be defined only in terms of the following claims as may be amended, with each claim being expressly incorporated into this Description of Specific Embodiments as an embodiment of the invention.

What is claimed is:

1. A boom assembly comprising:
a RF feeding coaxial cable comprising:
an outer conductor; and
a central conductor;
a first boom component, the first boom component coupled to the central conductor and configured as an antenna radiating element; and
a second boom component electrically isolated from the first boom component, the second boom component having the RF feeding coaxial cable disposed within, the second boom component coupled to the outer conductor and configured as an antenna sleeve radiating element.

2. The boom assembly of claim 1, further comprising:
a microphone; and
two or more electrical leads coupled to the microphone, the two or more electrical leads disposed within the first boom component and the second boom component.

3. The boom assembly of claim 2, wherein the two or more electrical leads are within a coaxial conductive shield.

4. The boom assembly of claim 2, wherein the two or microphone leads and the microphone extend beyond a first end of the first boom component.

5. The boom assembly of claim 2, wherein the microphone is disposed at a first end of the first boom component.

6. The boom assembly of claim 1, wherein the first boom component and the second boom component are planar.

7. The boom assembly of claim 1, wherein the first boom component and the second boom component are tubular.

8. The boom assembly of claim 1, wherein the first boom component comprises an aperture disposed at a first end arranged to receive a user voice sound wave and transmit the user voice sound wave to a microphone disposed at a headset housing coupled to the boom assembly.

9. The boom assembly of claim 8, wherein the aperture is coupled to a voice tube disposed within the first boom component and the second boom component.

10. The boom assembly of claim 1, wherein the first boom component has an electrical length of approximately a one-quarter wavelength and the second boom component has an electrical length of approximately a one-quarter wavelength.

11. The boom assembly of claim 1, wherein the first boom component is sized to fit within the second boom component and arranged to extend or retract telescopically with respect to the second boom component.

12. The boom assembly of claim 1, wherein the first boom component comprises a first conductive coating disposed on a plastic boom housing and the second boom component comprises a second conductive coating disposed on the plastic boom housing.

13. The boom assembly of claim 1, wherein the first boom component comprises a first plastic member having a first conductive coating and the second boom component comprises a second plastic member having a second conductive coating.

14. The boom assembly of claim 13, wherein the first conductive coating is a metal deposited on a surface of the first plastic member.

15. The boom assembly of claim 13, wherein the first conductive coating is a copper foil on a surface of the first plastic member.

16. The boom assembly of claim 1, wherein the first boom component is a first metal tube and the second boom component is a second metal tube.

17. The boom assembly of claim 1, wherein the first boom component and the second boom component are different sections of a single piece boom.

18. The boom assembly of claim 1, wherein the first boom component comprises a first conductive coating disposed on a first section of a boom housing and the second boom component comprises a second conductive coating disposed on a second section of the boom housing.

19. The boom assembly of claim 1, wherein an insulating sleeve is disposed between the first boom component and the second boom component.

20. A headset comprising:
a body configured to be worn on a user ear;
a boom coupled to the body comprising:
a radiating element; and
a sleeve radiating element arranged to be electrically isolated from the radiating element; and
a RF feeding coaxial cable disposed within the sleeve radiating element, the RF feeding coaxial cable comprising an outer conductor and a central conductor, wherein the outer conductor is coupled to the sleeve radiating element.

21. The headset of claim 20, wherein the central conductor is coupled to the radiating element.

22. The headset of claim 20, further comprising:
a microphone disposed at a distal end of the boom away from the body; and
two or more electrical leads coupled to the microphone, the two or more electrical leads disposed within the boom.

23. The headset of claim 20, wherein the boom comprises an aperture disposed at a distal end of the boom away from the body and arranged to receive a user voice sound wave and transmit the user voice sound wave to a microphone disposed at the body.

24. The headset of claim 23, wherein the aperture is coupled to a voice tube disposed within the boom.

25. The headset of claim 20, wherein the radiating element has an electrical length of approximately a one-quarter wavelength and the sleeve radiating element has an electrical length of approximately a one-quarter wavelength.

26. The headset of claim 20, wherein the boom is configured to extend or retract in length.

27. The headset of claim 20, wherein the radiating element and the sleeve radiating element form a boom housing structure.

28. The headset of claim 20, wherein the radiating element, the sleeve radiating element, and the RF feeding coaxial cable are disposed within an outer boom housing structure.
